(19) United States
(12) Patent Application Publication
(10) Pub. No.: US 2016/0053902 A1
(43) Pub. Date: Feb. 25, 2016

(54) CHECK VALVE

(71) Applicant: Summit Energy Services, Inc., Fort Worth, TX (US)

(72) Inventors: Mitchel D. Hansen, Aledo, TX (US); Andrew M. Eldridge, Fort Worth, TX (US); Jose I. Molina, Arlington, TX (US); Jonathan C. Hissam, Grand Prairie, TX (US)

(21) Appl. No.: 14/468,003

(22) Filed: Aug. 25, 2014

(51) Int. Cl. F16K 15/02

(52) U.S. Cl. CPC F16K 15/02

(57) ABSTRACT

A check valve comprising a valve housing having an input opening and an output opening, a first sealing mechanism disposed in the valve housing, said first sealing mechanism having a valve head coupled with an overmold layer, a second sealing mechanism disposed in the valve housing, said second sealing mechanism having a seal coupled with a seal retainer, and a compression device coupled with the first and second sealing mechanisms, wherein said compression device is configured to exert a force on the first and second sealing mechanisms.

### TECHNICAL FIELD

The present application relates generally to check valves, and more specifically to check valves used in float equipment.

### BACKGROUND OF THE INVENTION

Check valves in float equipment typically use a one-piece valve head “overmold,” where the entire valve head is molded and the seal mechanism is a single piece. These types of seal mechanisms can be damaged during use and the seal mechanism often becomes de-bonded. If damage to the seal is experienced, the valve will not be able to prevent fluid flow.

### SUMMARY OF THE INVENTION

A check valve is provided that includes a valve housing having an input opening and an output opening. A first sealing mechanism within the valve housing has a valve head that is coupled to an overmold layer. A compression device coupled to the first sealing mechanism exerts a force on the first sealing mechanism.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a cross section of a check valve in accordance with an exemplary embodiment of the present disclosure;

FIG. 2 is a cross section of a valve head and overmold layer in accordance with an exemplary embodiment of the present disclosure;

FIG. 3 is a cross section of a valve seal in accordance with an exemplary embodiment of the present disclosure;

FIG. 4 is a cross section of a seal retainer in accordance with an exemplary embodiment of the present disclosure;

FIGS. 5(a)-(c) are different views of a spring retainer in accordance with an exemplary embodiment of the present disclosure;

FIG. 6 is a cross section of a check valve in accordance with an exemplary embodiment of the present disclosure; and

FIG. 7 is a cross section of a valve head and overmold layer in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

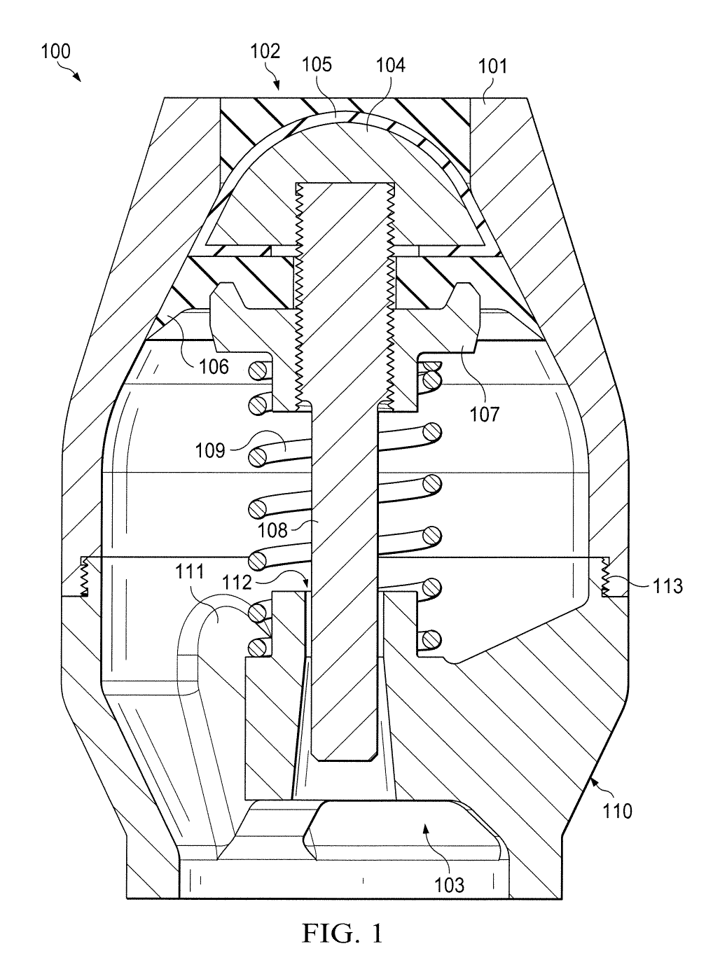

FIG. 1 is a cross section of a check valve 100 in accordance with an exemplary embodiment of the present disclosure. As shown in FIG. 1, check valve 100 includes a valve seat 101 and spring retainer 110 for housing the internal structure of the check valve. Check valve 100 also includes an input opening 102 and an output opening 103 allowing for the flow of concrete, mud, or other fluids in one direction while preventing flow in the reverse direction. Additionally, check value 100 comprises a valve head 104 coupled with overmold layer 105, a seal 106 coupled to valve head 104 by a seal retainer 107, a valve stem 108 extending into stem guide 112, and a spring 109 coupled with a spring retainer 110. Check valve 100 can be fabricated from a composite material such as phenolic resin, metal including aluminum and phosphorus bronze, rubber, elastic polymer, any other suitable material, or a combination of suitable materials, except for spring 109, which is metal or other suitable material, capable of sustaining elevated temperatures and high pressures.

In one exemplary embodiment of the present disclosure, input opening 102 of check valve 100 is sealed by two sealing mechanisms, each capable of providing a high pressure seal independently of one another. In the event that one of the seal mechanisms is damaged or otherwise rendered non-functional, the other seal mechanism can continue to prevent fluid flow.

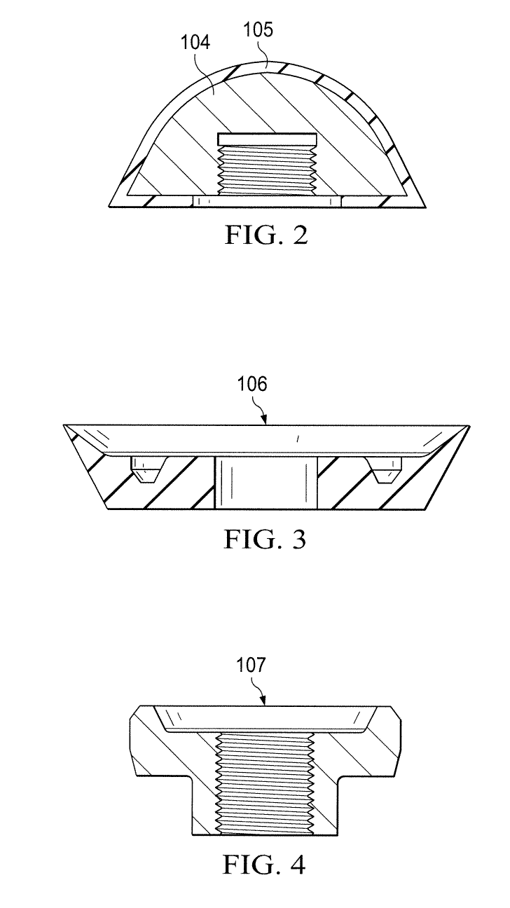

FIG. 2 is a cross section of valve head 104 and overmold layer 105 in accordance with an exemplary embodiment of the present disclosure. As shown in FIG. 2, the first sealing mechanism comprises a valve head 104 coupled with an overmold layer 105. The valve head 104 and overmold layer 105 are configured to form a high pressure seal with input opening 102. Overmold layer 105 can be formed from rubber, elastic polymer, any other suitable material or a combination of suitable materials to provide a seal with input opening 102. Overmold layer 105 can be positioned on valve head 104 using overmolding, injection molding, wrapping, or any suitable alternative process.

Referring again to FIG. 1, the second sealing mechanism comprises a seal 106 coupled to valve head 104 and valve stem 108 by a seal retainer 107. Seal 106 can be formed from rubber, elastic polymer, phenolic resin, aluminum, any other suitable material or a combination of suitable materials that are mechanically coupled to valve head 104 and valve stem 108 by seal retainer 107. Valve head 104, seal retainer 107, and valve stem 108 can be formed from phenolic resin, aluminum, rubber, elastic polymer, any suitable material or a combination of suitable materials.

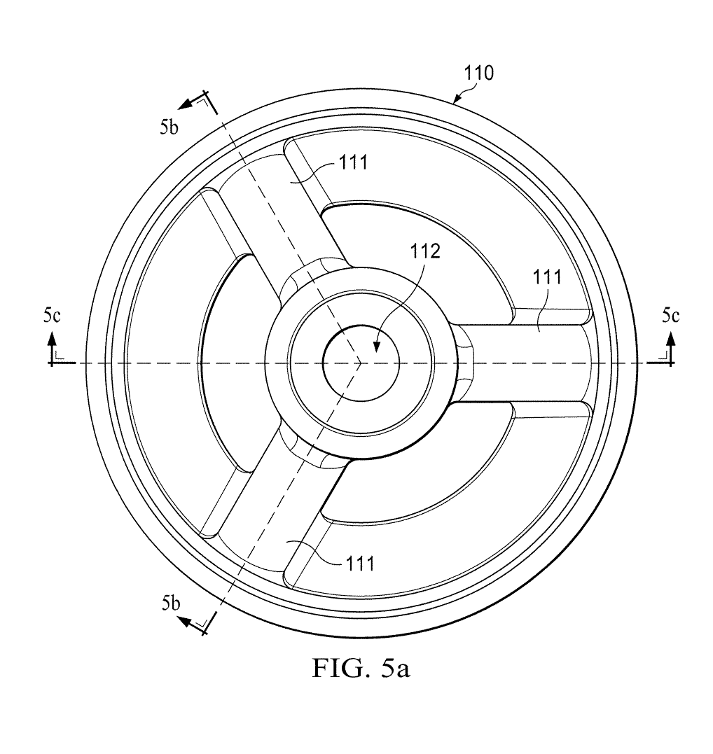

FIG. 3 is a cross section of valve seal 106 in accordance with an exemplary embodiment of the present disclosure. As shown in FIG. 3, valve seal 106 can have grooves or depressions that allow for coupling with seal retainer 107.

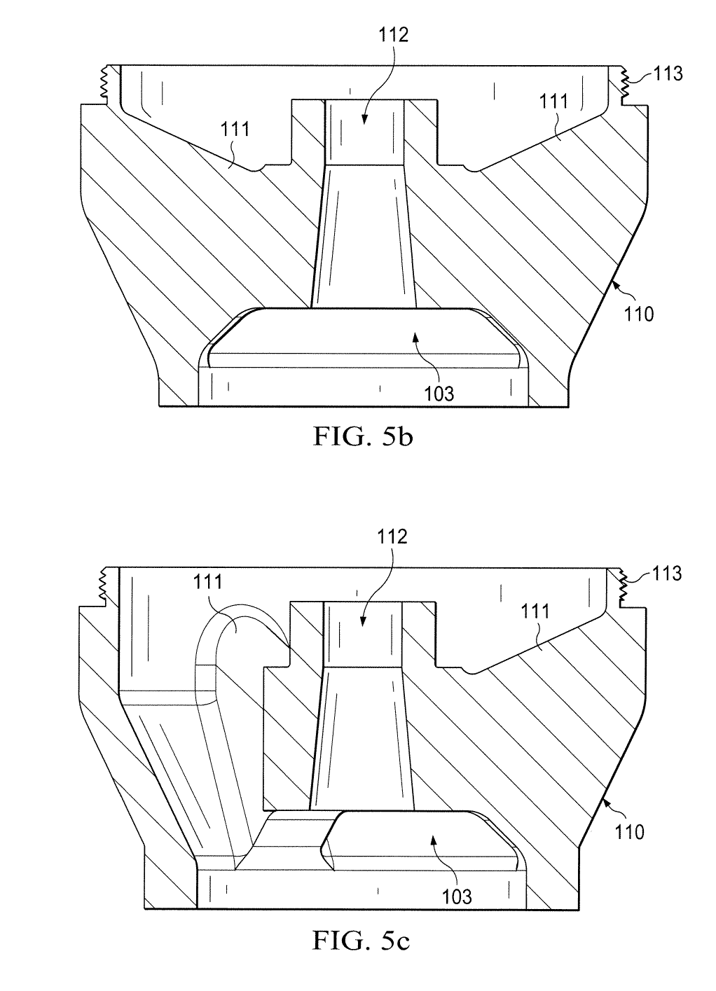

FIG. 4 is a cross section of seal retainer 107 in accordance with an exemplary embodiment of the present disclosure. As shown in FIG. 4, seal retainer 107 can have a structure configured to couple with seal 106. Additionally, in an exemplary embodiment of the present disclosure, seal retainer 107 can have internal threading allowing for mechanical coupling with valve stem 108.

In one exemplary embodiment of the present disclosure, seal retainer 107 and valve head 104 are coupled with valve stem 108 using threading, bonding, or any suitable alternative. The coupling of seal retainer 107 and valve stem 108 establishes the coupling of seal 106 and valve head 104. By mechanically fastening valve seal 106 to valve head 104 and valve stem 107 using seal retainer 108, the present disclosure prevents issues associated with valve bonded seals becoming de-bonded as a result of wear and use.

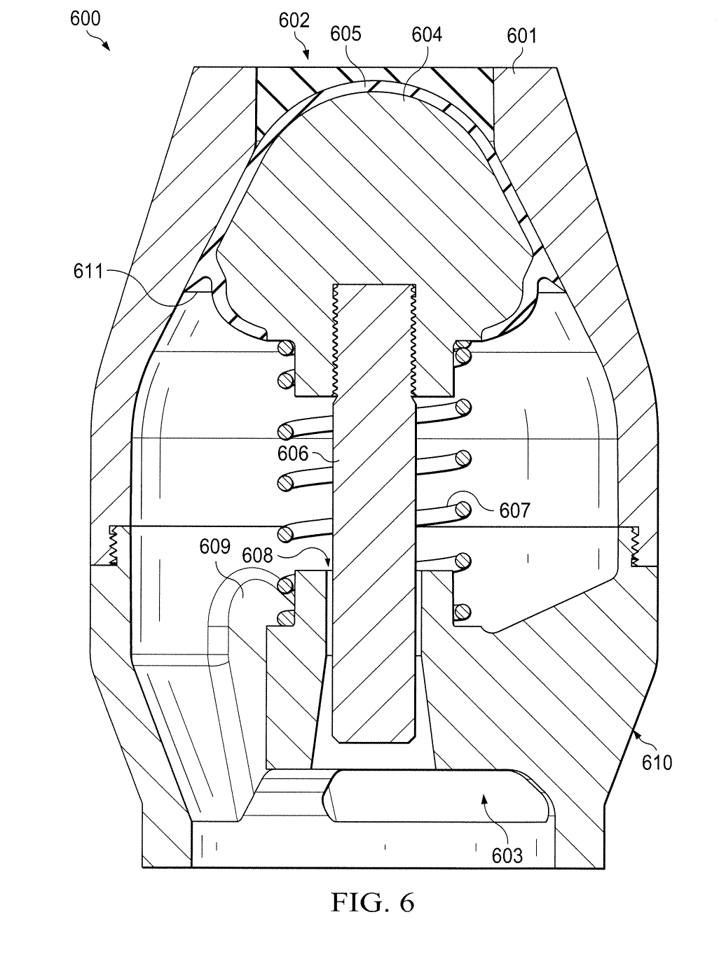

FIGS. 5(a)-(c) are several views of spring retainer 110 in accordance with an exemplary embodiment of the present disclosure. As shown in FIG. 5(a), spring retainer 110 can have a number of legs 111 configured to support spring 109. Spring retainer 110 also comprises output opening 103 to allow for the flow of mud, concrete, or other fluid through check valve 100. In one exemplary embodiment of the present disclosure, spring retainer 110 can be coated or molded to prevent the surface wear normally experienced in valves after several hours of mud, concrete, or other fluid circulation. The coating or molding of spring retainer 110 can be formed from rubber, elastic polymer, phenolic resin, metal such as phosphorus bronze or other suitable alternatives, any other suitable material or a combination of suitable materials for reducing surface wear and sustaining the integrity of check valve 100.

In one exemplary embodiment of the present disclosure shown in FIGS. 5(b) and (c), spring retainer 110 can have threading 113 to facilitate mechanical coupling to valve seat 101. In this embodiment, valve seat 101 and spring retainer 110 can be mechanically connected using threading, molding, latching, or any other suitable alternatives.

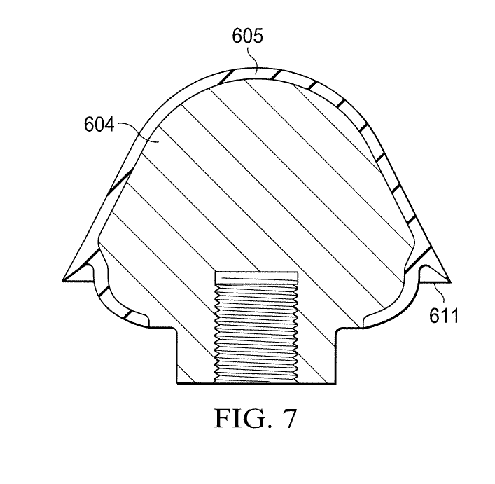

FIG. 6 is a cross section of a check valve 600 in accordance with an exemplary embodiment of the present disclosure. As shown in FIG. 6, check valve 600 includes a valve seat 601 and spring retainer 610 for housing the internal structure of the check valve. Check valve 600 also includes an input opening 602 and an output opening 603 allowing for the flow of concrete, mud, or other fluids in one direction while preventing flow in the reverse direction. Additionally, check value 600 comprises a valve head 604 coupled with overmold layer 605, a valve stem 606 extending into stem guide 608, and a spring 607 coupled with a spring retainer 610 having a number of legs 609. As previously discussed, check valve 600 may be a composite material such as phenolic resin, metal including aluminum and phosphorus bronze, rubber, elastic polymer, any other suitable material, or a combination of suitable materials, except for spring 607, which is metal or other suitable material, capable of sustaining elevated temperatures and high pressures.

In one exemplary embodiment of the present disclosure, valve head 604 and overmold layer 605 of check valve 600 are configured to form a high pressure seal with input opening 602.

FIG. 7 is a cross section of valve head 604 and overmold 605 layer 605, in accordance with an exemplary embodiment of the present disclosure. As shown in FIG. 7, valve head 604 and overmold layer 605 are configured to form a high pressure seal with input opening 602. As previously discussed, overmold layer 605 can be formed from rubber, elastic polymer, any other suitable material or a combination of suitable materials to provide a seal with input opening 602. Overmold layer 605 can be positioned on valve head 604 using overmolding, injection molding, wrapping, or any suitable alternative. Overmold layer 605 can fully or partially encompass valve head 604.

In one exemplary embodiment of the present disclosure, valve head 604 is coupled with valve stem 606 using threading, bonding, or any suitable alternative. By mechanically fastening valve head 604 and valve stem 606, the present disclosure prevents issues associated with valve bonded seals becoming de-bonded as a result of wear and use.

In another exemplary embodiment of the present disclosure, valve head 604 and overmold layer 605 can be oblong to match the dimensions of input opening 602 and therefore form a more secure seal.

In yet another exemplary embodiment of the present disclosure, overmold layer 605 can be configured to have a protruding lip 611 configured to interface with valve seat 601. In this manner, protruding lip 611 of overmold layer 605 prevents the reverse flow of liquids when valve head 604 and overmold layer 605 are engaged with input opening 602.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A check valve comprising:
a valve housing having an input opening and an output opening;
a first sealing mechanism disposed in the valve housing, the first sealing mechanism having a valve head coupled with an overmold layer; and
a compression device coupled to the first sealing mechanism, wherein the compression device is configured to exert a force on the first sealing mechanism.

2. The check valve of claim 1, further comprising a second sealing mechanism disposed in the valve housing, the second sealing mechanism having a seal coupled with a seal retainer, wherein the compression device is coupled to the first and second sealing mechanisms, and wherein the compression device is configured to exert a force on the first and second sealing mechanisms.

3. The check valve of claim 2, wherein the compression device further comprises:
a valve stem connected to the first and second sealing mechanisms wherein one end of said valve stem extends into the stem guide of the valve housing; and
a spring disposed around the valve stem, the spring exerting a force on the first and second sealing mechanisms.

4. The check valve of claim 3, wherein the valve stem is mechanically connected to the valve head of the first sealing mechanism.

5. The check valve of claim 3, wherein the valve stem is mechanically connected to the seal retainer of the second sealing mechanism.

6. The check valve of claim 5, wherein the seal is mechanically connected to the seal retainer of the second sealing mechanism.

7. The check valve of claim 1, wherein the valve housing further comprises a valve seat having the input opening and a spring retainer having the output opening, wherein the valve seat and the spring retainer are coupled to form the valve housing.

8. The check valve of claim 7, wherein the valve seat and the spring retainer are mechanically connected using threading on the valve seat and the spring retainer.

9. The check valve of claim 7, wherein an interior surface of the spring retainer is coated with rubber, elastic polymer, phenolic resin, metal, any other suitable material or a combination thereof.

10. The check valve of claim 1, wherein an interior surface of the valve seat comprises rubber, elastic polymer, phenolic resin, metal, any other suitable material or a combination thereof.

11. The check valve of claim 1, wherein the valve head comprises rubber, elastic polymer, phenolic resin, metal, any other suitable material or a combination thereof.

12. The check valve of claim 1, wherein overmold layer further comprises a protruding lip configured to interface with the valve housing.

13. A check valve comprising:
a valve housing having an input opening and an output opening;
a first sealing mechanism disposed in the valve housing, the first sealing mechanism having a valve head coupled with an overmold layer, the overmold layer further comprising a protruding lip configured to interface with the valve housing; and
a compression device coupled to the first sealing mechanism, wherein the compression device is configured to exert a force on the first sealing mechanism.

14. The check valve of claim 13, wherein the valve housing further comprises a valve seat having the input opening and a spring retainer having the output opening, wherein the valve seat and the spring retainer are coupled to form the valve housing.

15. The check valve of claim 14, wherein the valve seat and the spring retainer are mechanically connected using threading on the valve seat and the spring retainer.

16. The check valve of claim 14, wherein an interior surface of the spring retainer is coated with rubber, elastic polymer, phenolic resin, metal, any other suitable material or a combination thereof.

17. The check valve of claim 13, wherein an interior surface of the valve seat comprises rubber, elastic polymer, phenolic resin, metal, any other suitable material or a combination thereof.

18. The check valve of claim 13, wherein the valve head comprises rubber, elastic polymer, phenolic resin, metal, any other suitable material or a combination thereof.

19. The check valve of claim 13, wherein the valve head has an oblong configuration.

20. A check valve comprising:
a valve seat having an input opening and a spring retainer having an output opening, wherein the valve seat and the spring retainer are coupled to form a valve housing;
a first sealing mechanism disposed in the valve housing, the first sealing mechanism having a valve head coupled with an overmold layer wherein the overmold layer further comprises a protruding lip configured to interface with the valve housing;
a second sealing mechanism disposed in the valve housing, the second sealing mechanism having a seal coupled with a seal retainer; and
a compression device coupled with the first and second sealing mechanisms, the compression device having:
a valve stem connected to the first and second sealing mechanisms wherein one end of the valve stem extends into the stem guide of the valve housing; and
a spring disposed around the valve stem, the spring exerting a force on the first and second sealing mechanisms.
